(19) United States
(12) Patent Application Publication
(10) Pub. No.: US 2026/0052109 A1
(43) Pub. Date: Feb. 19, 2026

(54) PACKET DATA UNIT SET-DEPENDENT CONGESTION MARKING

(71) Applicant: QUALCOMM Incorporated, San Diego, CA (US)

(72) Inventors: Saadallah KASSIR, San Diego, CA (US); Hyun Yong LEE, San Diego, CA (US); Ravi AGARWAL, San Diego, CA (US); Prashanth Haridas HANDE, San Diego, CA (US); Peerapol TINNAKORNSRISUPHAP, San Diego, CA (US)

(21) Appl. No.: 18/805,043

(22) Filed: Aug. 14, 2024

(51) Int. Cl. H04L 47/31; H04L 47/24; H04L 47/32

(52) U.S. Cl. CPC H04L 47/31; H04L 47/24; H04L 47/32

(57) ABSTRACT

Methods, systems, and devices for wireless communications are described. Techniques described herein may enable a network entity to determine whether to indicate, to a user equipment (UE), that congestion is experienced based on one or more features of a packet data unit (PDU) set. For example, the network entity may adjust a marking policy associated with the PDU set based on a PDU set size, a PDU set delay budget (PSDB), whether pacing is used to transmit the PDU set, a deadline associated with the PDU set, and the like. The network entity may receive the features of the PDU set from a management entity, such as an application server, via a quality of service (QoS) profile.

### FIELD OF TECHNOLOGY

The following relates to wireless communications, including packet data unit (PDU) set-dependent congestion marking.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first network entity is described. The method may include receiving a control message indicating a packet data unit (PDU) set-specific feature associated with a PDU set, receiving one or more PDUs of the PDU set, and outputting the one or more PDUs of the PDU set, where a value of a congestion decision indicated by a congestion marking field of the one or more PDUs output by the first network entity is adjusted based on the PDU set-specific feature associated with the PDU set.

A first network entity for wireless communications is described. The first network entity may include one or more memories storing processor executable code, and one or more processors coupled with the one or more memories. The one or more processors may individually or collectively be operable to execute the code to cause the first network entity to receive a control message indicating a PDU set-specific feature associated with a PDU set, receive one or more PDUs of the PDU set, and output the one or more PDUs of the PDU set, where a value of a congestion decision indicated by a congestion marking field of the one or more PDUs output by the first network entity is adjusted based on the PDU set-specific feature associated with the PDU set.

Another first network entity for wireless communications is described. The first network entity may include means for receiving a control message indicating a PDU set-specific feature associated with a PDU set, means for receiving one or more PDUs of the PDU set, and means for outputting the one or more PDUs of the PDU set, where a value of a congestion decision indicated by a congestion marking field of the one or more PDUs output by the first network entity is adjusted based on the PDU set-specific feature associated with the PDU set.

A non-transitory computer-readable medium storing code for wireless communications is described. The code may include instructions executable by one or more processors to receive a control message indicating a PDU set-specific feature associated with a PDU set, receive one or more PDUs of the PDU set, and output the one or more PDUs of the PDU set, where a value of a congestion decision indicated by a congestion marking field of the one or more PDUs output by the first network entity is adjusted based on the PDU set-specific feature associated with the PDU set.

In some examples of the method, first network entities, and non-transitory computer-readable medium described herein, receiving the control message indicating the PDU set-specific feature may include operations, features, means, or instructions for receiving an indication of a PDU set delay budget (PSDB) associated with the PDU set, where the value of the congestion decision indicated by the congestion marking field may be adjusted based on a function of the PSDB for the one or more PDUs output by the first network entity.

In some examples of the method, first network entities, and non-transitory computer-readable medium described herein, receiving the control message indicating the PDU set-specific feature may include operations, features, means, or instructions for receiving an indication of a PDU set size associated with the PDU set, where the value of the congestion decision indicated by the congestion marking field may be adjusted based on a packet index for the one or more PDUs output by the first network entity.

In some examples of the method, first network entities, and non-transitory computer-readable medium described herein, receiving the control message indicating the PDU set-specific feature may include operations, features, means, or instructions for receiving an indication of a deadline associated with the PDU set, where the value of the congestion decision indicated by the congestion marking field may be adjusted based on an amount of remaining time before the deadline for the one or more PDUs output by the first network entity.

In some examples of the method, first network entities, and non-transitory computer-readable medium described herein, receiving the control message indicating the PDU set-specific feature may include operations, features, means, or instructions for receiving an indication of one or more quality of service (QoS) parameters associated with the PDU set, where the value of the congestion decision indicated by the congestion marking field may be adjusted based on the one or more QoS parameters.

In some examples of the method, first network entities, and non-transitory computer-readable medium described herein, receiving the control message indicating the PDU set-specific feature may include operations, features, means, or instructions for receiving an indication of pacing information associated with the PDU set, where the value of the congestion decision indicated by the congestion marking field may be adjusted based on the pacing information.

Some examples of the method, first network entities, and non-transitory computer-readable medium described herein may further include operations, features, means, or instructions for adjusting the value of the congestion decision indicated by the congestion marking field based on the PDU set-specific feature.

In some examples of the method, first network entities, and non-transitory computer-readable medium described herein, adjusting the value of the congestion decision may include operations, features, means, or instructions for adjusting a probability associated with indicating, via the congestion marking field, that congestion may be experienced based on the PDU set-specific feature.

In some examples of the method, first network entities, and non-transitory computer-readable medium described herein, adjusting the value of the congestion decision may include operations, features, means, or instructions for indicating, via the congestion marking field, that congestion may be experienced based on the PDU set-specific feature.

In some examples of the method, first network entities, and non-transitory computer-readable medium described herein, adjusting the value of the congestion decision may include operations, features, means, or instructions for refraining from indicating, via the congestion marking field, that congestion may be experienced based on the PDU set-specific feature.

In some examples of the method, first network entities, and non-transitory computer-readable medium described herein, receiving the control message indicating the PDU set-specific feature may include operations, features, means, or instructions for receiving a QoS profile including an indication of the PDU set-specific feature.

Some examples of the method, first network entities, and non-transitory computer-readable medium described herein may further include operations, features, means, or instructions for selecting a marking policy associated with adjusting the value of the congestion decision indicated by the congestion marking field of the one or more PDUs based on the PDU set-specific feature.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports packet data unit (PDU) set-dependent congestion marking in accordance with one or more aspects of the present disclosure.

FIG. 2 shows an example of a wireless communications system that supports PDU set-dependent congestion marking in accordance with one or more aspects of the present disclosure.

FIG. 3 shows an example of a wireless communications system that supports PDU set-dependent congestion marking in accordance with one or more aspects of the present disclosure.

FIG. 4 shows an example of a process flow that supports PDU set-dependent congestion marking in accordance with one or more aspects of the present disclosure.

FIGS. 5 and 6 show block diagrams of devices that support PDU set-dependent congestion marking in accordance with one or more aspects of the present disclosure.

FIG. 7 shows a block diagram of a communications manager that supports PDU set-dependent congestion marking in accordance with one or more aspects of the present disclosure.

FIG. 8 shows a diagram of a system including a device that supports PDU set-dependent congestion marking in accordance with one or more aspects of the present disclosure.

FIGS. 9 through 11 show flowcharts illustrating methods that support PDU set-dependent congestion marking in accordance with one or more aspects of the present disclosure.

### DETAILED DESCRIPTION

In some wireless communication systems, a network entity (e.g., a radio access network (RAN) node) may output a set of packets (e.g., a packet data unit (PDU)) to a user equipment (UE). In some examples, the network entity may indicate, via a congestion marking field included in up to each packet of the set of packets, whether congestion is experienced at the network entity. For example, if a quantity of packets in a queue of the network entity is below a first threshold, the network entity may not indicate that congestion is experienced. If the quantity of packets in the queue of the network entity is above a second threshold, the network entity may indicate that congestion is experienced. If the quantity of packets in the queue of the network entity is between the first and second thresholds, the network entity may indicate that congestion is experienced with some probability. In some examples, however (e.g., if an application server uses pacing when transmitting PDU sets or if a first PDU set is relatively larger than a second PDU set), the quantity of packets in the queue of the network entity may be above the second threshold, which may result in the network entity indicating that congestion is experienced and may therefore cause the UE to reduce a bitrate associated with an application of the UE. The relatively lower bitrate may result in a reduced user experience.

Accordingly, techniques described herein may enable the network entity to determine whether to indicate that congestion is experienced based on one or more features of a PDU set. For example, the network entity may adjust a marking policy associated with the PDU set based on a PDU set size, a PDU set delay budget (PSDB), whether the application server uses pacing to transmit the PDU set, a deadline associated with the PDU set, and the like. The network entity may receive the features of the PDU set from a management entity (e.g., via a quality of service (QoS) profile). Such techniques may reduce or increase a quantity of packets indicating that congestion is experienced, which may enable the UE to use a relatively more appropriate (e.g., higher or lower) bitrate and may therefore increase user experience.

Aspects of the disclosure are initially described in the context of wireless communications systems. Aspects of the disclosure are further illustrated by and described with reference to process flows, apparatus diagrams, system diagrams, and flowcharts that relate to PDU set-dependent congestion marking.

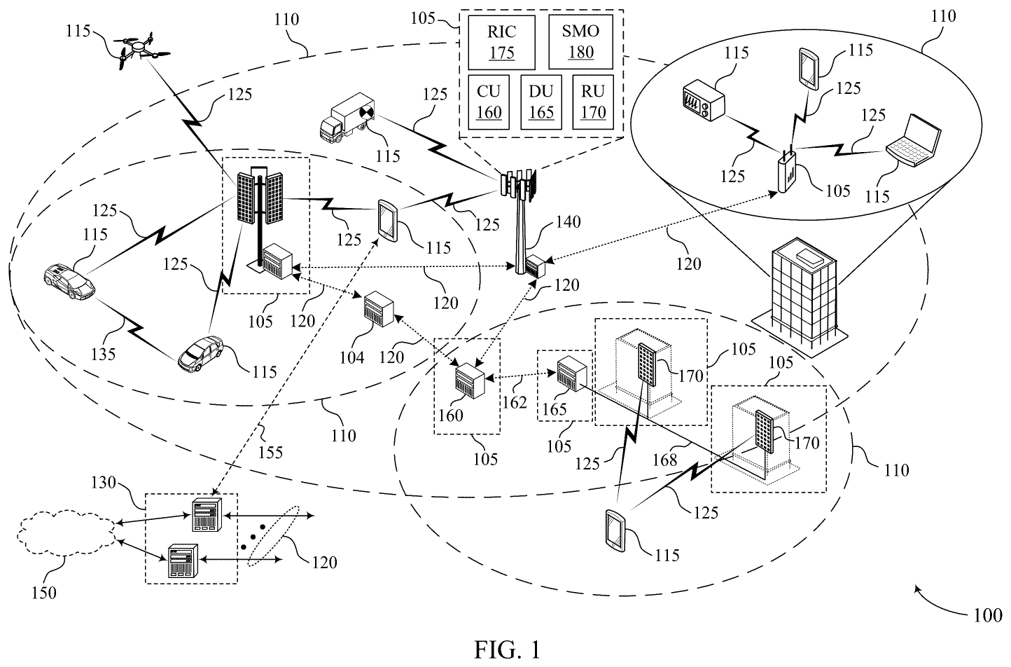

FIG. 1 shows an example of a wireless communications system 100 that supports PDU set-dependent congestion marking in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some UEs 115 may be extended reality (XR) devices that support XR data communications. XR data may include virtual reality (VR), augmented reality (AR), or mixed reality (MR) data. In some examples, transmissions to an XR UE 115 may be downlink or sidelink transmissions from a companion device (e.g., another UE 115), which may include video frame data transmissions for projection to a user of the XR UE 115. The XR UE 115 may receive a configuration indicating a configured grant (CG) for multi-physical uplink shared channel (PUSCH) transmissions (e.g., video frames with relatively large and/or variable sizes). The CGs for the PUSCH transmissions may be configured to match traffic metrics and to avoid latency associated with dynamic grant (DG) configurations. In some examples, the configuration indicating the CG may indicate for the XR UE 115 to access an NR unlicensed (NR-U) channel (e.g., as a complement of licensed Uu interface), which may improve a capacity for XR UEs 115 (e.g., due to increased channels used by the XR UEs 115). The XR UEs 115 may experience a relatively smaller PDB than some other UEs 115 (e.g., less than 10 ms), and may accordingly use some different traffic awareness and delay status reporting (DSR) procedures than the other UEs 115 (e.g., for NR-U or other channels).

In some examples of the wireless communication system 100, a network entity 105 (e.g., a RAN node) may determine whether to indicate, to a UE 115 via one or more packets of a PDU set, that congestion is experienced based on one or more features of the PDU set. In an example, packets of a PDU set may be collectively used to render a video frame, where the packets may need to be received within a certain time frame for timely rendering of the video frame. Untimely receipt of one or more packets of a particular PDU set may prevent the UE 115 from properly rendering the video frame, resulting in a degraded user experience.

In some examples, the network entity 105 may indicate that congestion is experienced via a Explicit Congestion Notification (ECN) field of the one or more packets of a PDU set. For example, the network entity 105 may adjust a marking policy associated with the PDU set based on a PDU set size, a PSDB, whether an application server uses pacing to transmit the PDU set, a deadline associated with the PDU set, and the like. The network entity may receive the features of the PDU set from a management entity (e.g., via a QoS profile). Such techniques may reduce a quantity of packets indicating that congestion is experienced, which may enable the UE to use a relatively higher bitrate and may therefore increase user experience.

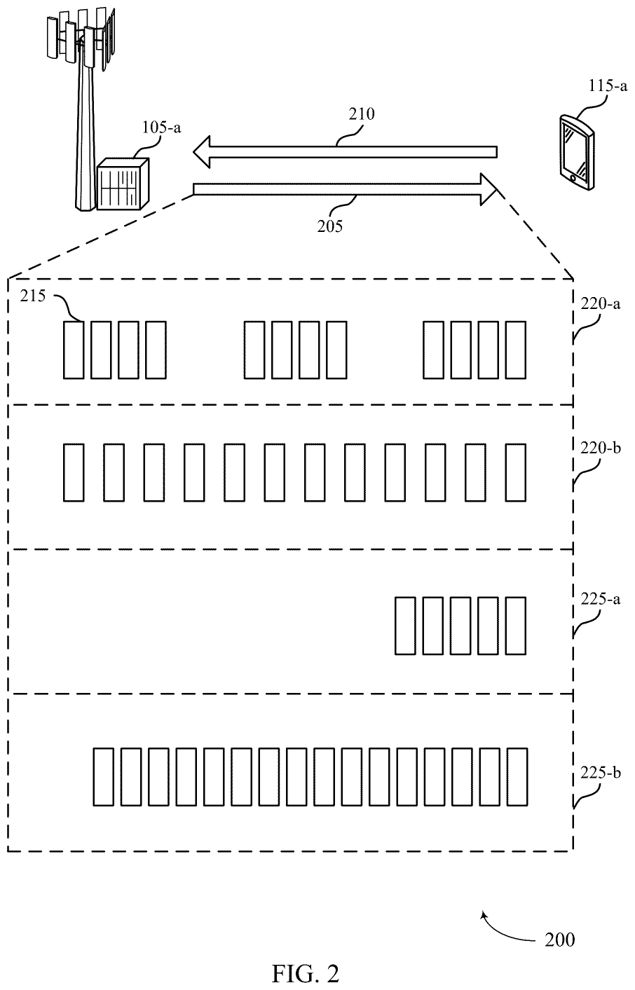

FIG. 2 shows an example of a wireless communications system 200 that supports PDU set-dependent congestion marking in accordance with one or more aspects of the present disclosure. The wireless communications system 200 may implement or may be implemented by aspects of the wireless communications system 100. For example, the wireless communications system 200 may be implemented by a UE 115-a, network entity 105-a (e.g., a RAN node), and an application server, which may be examples of UEs 115 and network entities 105 as described with reference to FIG. 1.

In some examples of the wireless communications system 200, a UE 115-a may receive one or more PDUs 215 from a network entity 105-a via a downlink channel 205, or may transmit one or messages (e.g., feedback messages, uplink messages) to the network entity 105-a via an uplink channel 210. In some examples, the UE 115-a may be an XR device (e.g., an XR-capable smart phone, XR glasses, XR gloves, and the like), which may be associated with relatively more strict QoS constraints than some other UEs 115. For example, the UE 115-a may communicate using a relatively lower latency, a relatively higher reliability, a relatively higher bandwidth, and/or a relatively lower device power consumption than some other UEs 115. In some examples, the PDUs 215 may be examples of video packets.

As described herein, a PDU set may be a set of packets (e.g., a set of PDUs 215) that may be jointly processed by applications. A burst may be a set of PDUs that are generated by applications during a same time period (e.g., at roughly the same time, such as within a threshold time from one another). In some examples, one or more applications used by the UE 115-a may identify a threshold granularity of application data (e.g., a minimum granularity) to be available on a client side (e.g., by the UE 115-a) before beginning another level of processing. For example, in some configurations, application client processing may begin if a threshold percentage of bits (e.g., or all bits) of a video frame are available. Accordingly, to meet a threshold granularity of traffic consumption of the application client side, a threshold quantity of IP packets (e.g., a minimum set of IP packets) may be available at the application client side prior to begging another level of processing. Such a threshold quantity of IP packets may be referred to herein as a PDU set. In some examples, if the UE 115-a is an XR device (e.g., with XR or cloud gaming traffic), the UE 115-a may receive bursts of traffic that may carry one or more PDU sets.

In some examples, to reduce an end-2-end (E2E) delay associated with communications with the UE 115-a, the wireless communications system 200 may use video adaptation mechanism to adjust a video coding bitrate according to network congestion. For example, the wireless communications system 200 may use an over the top (OTT) algorithm in which the UE 115-a (e.g., a smart phone or smart glasses) may provide congestion information or measurements (e.g., a round trip time (RTT)) as feedback to a server using Real-Time Transport Control Protocol (RTCP). The server may adjust an encoding rate accordingly.

Additionally, or alternatively, the wireless communications system 200 may use a network-assisted algorithm in which the network (e.g., the network entity 105-a) may provide a congestion indication when congestion is experienced. For example, a switch relaying IP packets (e.g., the network entity 105-a) may use an Explicit Congestion Notification (ECN) field in an IP packet header to indicate whether congestion is experienced by the network entity 105-a. A rate adaptation client may use the congestion information indicated by the ECN field to detect congestions and inform the server whether congestion is experienced. In some examples, the network entity 105-a may leverage the ECN field in the IP header to provide the congestion information to an application-layer congestion control algorithm for low latency, low loss, and scalable throughput (L4S) network-assisted congestion control frameworks.

In some examples, an L4S framework may include components such as L4S-compliant E2E rate adaptation algorithms (e.g., running OTT at an application layer or at a transport layer), L4S-compliant active queue management (AQM), and a protocol between the L4S-compliant E2E rate adaptation algorithms and the L4S-compliant AQM (e.g., ECN marking in the IP header for congestion information exposure). The L4S-compliant E2E rate adaptation algorithms may be running on a server side (e.g., at an application server) or at a client side (e.g., at the UE 115-a). The L4S-compliant AQM may be running on a network node and/or a RAN node (e.g., the network entity 105-a).

In some examples, the application server may output one or more PDUs 215 (e.g., video data IP packets) to the UE 115-a via the network node and/or the RAN node (e.g., the network entity 105-a), and the UE 115-a may provide L4S feedback to the application server. The network node and/or the RAN node may use ECN marking to “mark” the one or more PDUs 215 (e.g., with some probability) to indicate that congestion is experienced at the network node and/or the RAN node. That is, the network node and/or the RAN node (e.g., the network entity 105-a) may adjust a value of a marking decision of an ECN field (e.g., a congestion marking field) of the PDUs 215.

An ECN protocol may indicate for the network entity 105-a to indicate, via the ECN field, that congestion is experienced according to Table 1 below.

TABLE 1

| Congestion | | |
|---|---|---|
| Decision | | |
| Value | Codepoint | Description |
| 00 | Not ECN | Not ECN Capable Transport |
| | capable | |
| | transport | |
| 10 | ECT(0) | ECN Capable (e.g., data center (DC) |
| | | transmission control protocol (TCP) |
| 01 | ECT(1) | L4S Capable (e.g., TCP Prague) |
| 11 | CE | Congestion Experienced (marked |
| | | packet) |

As illustrated with reference to Table 1, in some examples, if the network entity 105-a is not an ECN or L4S capable network entity 105-a (e.g., not an ECT), the network entity 105-a may indicate a first value (e.g., 00) via the ECN field. If the network entity 105-a is an ECN capable network entity 105-a (e.g., an ECT) or an L4S capable network entity 105-a, the network entity 105-a may set the value of the congestion decision (e.g., the value of the ECN field) to one or more second values (e.g., 10 or 01, respectively), to refrain from indicating that the network entity 105-a has experienced congestion. Additionally, or alternatively, the network entity 105-a may set the value of the congestion decision (e.g., the value of the ECN field) to a third value (e.g., 11) to indicate that the network entity 105-a has experienced congestion.

In some examples, a marking probability associated with marking the PDUs 215 to indicate that congestion is experienced by the network entity 105-a may be based on an extent of congestion (e.g., a queuing delay). For example, the network entity 105-a may identify a first threshold time (e.g., a minimum threshold) of the queuing delay for which the network entity 105-a may not set the value of the congestion decision to the third value (e.g., if the queuing delay does not satisfy the first threshold time). Additionally, or alternatively, the network entity 105-a may identify a second threshold time (e.g., a maximum threshold) of the queuing delay for which the network entity 105-a may set the value of the congestion decision to the third value (e.g., if the queuing delay satisfies the second threshold time).

If the queuing delay (e.g., in seconds) satisfies the first threshold time and does not satisfy the second threshold time, the network entity 105-a may set the value of the congestion decision to the third value with some probability (e.g., a probability that may increase linearly from 0 to 1 as the queuing delay increases from the first threshold to the second threshold). That is, the probability that the network entity 105-a may set the value of the congestion decision to the third value may be a function of a queue state of the network entity 105-a. Accordingly, an L4S capable node (e.g., the network entity 105-a may set the ECN field to the third value (e.g., to indicate that congestion is experienced) as an early congestion indicator (e.g., as compared to packet drop).

A receiving device (e.g., the UE 115-a) may read the value of the congestion decision (e.g., the ECN field) and report the value of the congestion decision to a server (e.g., in a TCP acknowledgment (ACK) header or an RTCP if Real-time Transport Protocol (RTP) is used on top of User Datagram Protocol (UDP)).

In some examples, a marking policy (e.g., a probability that the network entity 105-a may set the ECN field to the third value) may be vendor-specific, but may be a function of an L4S and classic queue sizes, queuing delays, and/or channel quality index (CQI). For example, the network entity 105-a may make ECN marking decisions (e.g., adjusting the value of the congestion decision indicated via the ECN field) based on a queue size, an estimated queuing delay, CQI, and the like. However, such metrics may not account for one or more traffic scenarios. For example, some applications or flows may have a relatively higher latency tolerance than some other applications or flows.

Additionally, or alternatively, some applications (e.g., an application server) may perform pacing of data packets (e.g., as shown with reference to the traffic flow 220-b), while some applications may not perform pacing of data packets (e.g., as shown with reference to the traffic flow 220-a), which may impact a marking behavior. For example, as illustrated with reference to the traffic flow 220-b, an application server may perform pacing by spacing out individual packets, which may reduce a packet queueing delay at the network entity 105-a (e.g., a bottleneck). In some examples, as illustrated with reference to the traffic flow 220-a, pacing may be undesired (e.g., to reduce power consumption of the UE 115-a or E2E video frame latency), and the application server may accordingly not perform pacing.

Accordingly, as data becomes more “bursty” (e.g., with relatively more bursts of data without pacing), one or more last PDUs 215 in a data burst may be systematically marked as being congested due to joining a busy queue of the network entity 105-a. This systematic marking may result in an impact on a marking behavior and overall system performance (e.g., due to preventing the application from using a relatively higher bitrate despite having available capacity). Thus, a PSDB-dependent ECN marking policy at the network entity 105-a may enable the UE 115-a to operate with a relatively higher bitrate, which may improve user experience.

Additionally, or alternatively, some video frame-size variations (e.g., a relatively smaller frame size, as illustrated with reference to a frame 225-a or a relatively larger frame size, as illustrated with reference to a frame 225-b) may trigger ECN marking unnecessarily, as some larger frames may experience self-inflected congestion and some smaller frames may be relatively less likely to be marked, which may bias a target bitrate. For example, some frames (e.g., the frame 225-a) may be P-frames, which may be relatively smaller (e.g., 5 times smaller) than I-frames (e.g., the frame 225-b). Accordingly, in the case of an I-Frame, one or more last packets in a burst may be systematically marked, which may impact user experience (e.g., by reducing a bitrate of one or more subsequent P-frames, which may prevent the application from using a relatively higher bitrate despite having available capacity). Thus, or PDU set size-dependent ECN marking policy at the network entity 105-a may enable the UE 115-a to operate with a relatively higher bitrate, which may improve user experience.

Accordingly, in some implementations, the network entity 105-a may determine the value of the congestion marking decision based on a PSDB of the PDU set (e.g., an upper bound on a delay experienced by the PDU set between a user plane function (UPF) and the UE 115-a). For example, the network entity 105-a may receive an indication of a PSDB for the PDU set from a session management function (SMF) (e.g., or one or more other devices of the wireless communication system 200, such as an application server, a UPF, a network exposure function (NEF), and the like) along with one or more other QoS parameters as part of a QoS profile.

The network entity 105-a may accordingly use the PSDB to enhance a marking policy. For example, the network entity 105-a may determine a probability of indicating, via the ECN field, that congestion is experienced as a function of a remaining PSDB (e.g., a PSDB margin). Table 1 provides illustrative examples of marking policy enhancements based on the PSDB. In some examples, however, the network entity 105-a may determine the value of the congestion decision according to one or more different rules than those illustrated with reference to Table 2.

TABLE 2

| Original ECN | | |
|---|---|---|
| Marking Decision | | |
| (without accounting | PSDB | |
| for PSDB) | Margin | Adjusted ECN Marking Decision |
| Mark or relatively | Large | No mark or lower marking |
| high marking | Margin | probability |
| probability | | |
| No mark or relatively | Low | Mark or higher marking probability |
| low marking | Margin or | |
| probability | PSDB | |
| | Exceeded | |

As an illustrative example, the network entity 105-a may not set the value of the congestion decision to the third value (e.g., 11 from Table 1) based on the queue delay (e.g., without accounting for the PSDB). However, as illustrated with refence to Table 2, if the PSDB has a relatively smaller margin (e.g., a relatively smaller remaining amount of time in the PSDB available for communication of the PDU set, such as a margin that is below a threshold), the network entity 105-a may determine to set the value of the congestion decision to the third value (e.g., 11 from Table 1), or to increase a probability of setting the value of the congestion decision to the third value.

Additionally, or alternatively, the network entity 105-a may set the value of the congestion decision to the third value based on the queue delay (e.g., without accounting for the PSDB). However, as illustrated with reference to Table 2, if the PSDB has a relatively larger margin (e.g., remaining time that is above the threshold), the network entity 105-a may adjust the value of the congestion decision to one of the second values (e.g., from the third value) or may decrease a probability of setting the value of the congestion decision to the third value.

Additionally, or alternatively, the network entity 105-a may use a deadline provided by the UE 115-a to determine whether to set the value of the congestion decision to the third value (e.g., if deadline-based scheduling is being performed). For example, the network entity 105-a may not set the value of the congestion decision to the third value based on the queue delay (e.g., without accounting for the deadline). However, if the deadline is within a threshold time, the network entity 105-a may adjust the value of the congestion decision to the third value (e.g., from one of the second values to indicate that congestion is being experienced) or may increase a probability of setting the value of the congestion decision to the third value. In some examples, such PSDB- or deadline-dependent packet marking may be applied for uplink and downlink traffic.

In some implementations, the network entity 105-a may determine the value of the congestion marking decision based on a size of the PDU set (e.g., a quantity of PDUs 215 composing the PDU set) or based on an index of a PDU within the PDU set. For example, the network entity 105-a may receive a PDU set size from the SMF (e.g., or one or more other devices of the wireless communication system 200, such as an application server, a UPF, a NEF, and the like) along with one or more other QoS parameters as part of a QoS profile. The network entity 105-a may accordingly use the PDU set size to enhance a marking policy. Additionally, or alternatively, the network entity 105-a may receive the PDU set size via the PDUs 215. For example, the PDUs 215 may include a PDU set size, Sequence Number, and End of PDU Set indicators as a PDU set metadata in an RTP Header Extension. Table 3 provides illustrative examples of marking policy enhancements based on the PDU set size and index. In some examples, however, the network entity 105-a may determine the value of the congestion decision according to one or more different rules than those illustrated with reference to Table 3.

TABLE 3

| Original ECN | | | |
|---|---|---|---|
| Marking | | | |
| Decision | | | |
| (without | | | |
| accounting | PSDB | Packet Index in | Adjusted ECN |
| for PSDB) | Margin | PDU Set Size | Marking Decision |
| No mark or | Low | Among last packets | No mark or lower |
| relatively low | Margin | in PDU set | marking probability |
| marking | | | |
| probability | | | |
| No mark or | PSDB | Any | Mark or higher |
| relatively low | Exceeded | | marking probability |
| marking | | | |
| probability | | | |

As an additional illustrative example, the network entity 105-a may set the value of the congestion decision to the third value based on the queue delay (e.g., and not based on the PDU set size). However, if the PDU set has a relatively smaller PDU set size (e.g., or a PDU 215 is among one or more last packets in the PDU set based on the PDU set seize), the network entity 105-a may adjust the value of the congestion decision to one of the second values (e.g., from the third value) or may decrease a probability of setting the value of the congestion decision to the third value, to avoid indicating that congestion is being experienced.

Additionally, or alternatively, the network entity 105-a may not set the value of the congestion decision to the third value based on the queue delay (e.g., and not based on the PDU set size). However, if the PDU set has a relatively larger PDU set size (e.g., or a PDU 215 is not among one or more last packets in the PDU set), the network entity 105-a may adjust the value of the congestion decision to the third value (e.g., from the one or more second values) or may increase a probability of setting the value of the congestion decision to the third value, to indicate congestion is being experienced.

Additionally, or alternatively, the network entity 105-a may use the PDU set size in conjunction with the PSDB to determine whether to set the value of the congestion decision to the third value. For example, if the PSDB is exceeded, the network entity 105-a may determine to adjust the value of the congestion decision to the third value from the one or more second values (e.g., even if a PDU 215 is not among one or more last packets in the PDU set), to indicate that congestion is being experienced. If the PSDB has a relatively small margin, but a PDU 215 is among one or more last packets in the PDU set, the network entity 105-a may determine to adjust the value of the congestion decision to one of the second values from the third value, to indicate less congestion is being experienced. In some examples, the network entity 105-a may not use the PDU set size in conjunction with the PSDB to determine whether to set the value of the congestion decision to the third value. In some examples, such PSDB-dependent packet marking may be applied for uplink and downlink traffic.

Additionally, or alternatively, the network entity 105-a may determine to adjust the value of the congestion decision based on one or more other QoS parameters (e.g., a packet error loss ratio, a guaranteed bit rate (GBR), a packet latency budget, a non-guaranteed bit rate (NGBR), and the like). For example, the network entity 105-a may determine to adjust the value of the marking decision from the third value to one of the second values (e.g., or from the one or more second values to the third value) based on one or more other QoS parameters of the QoS profile satisfying a threshold.

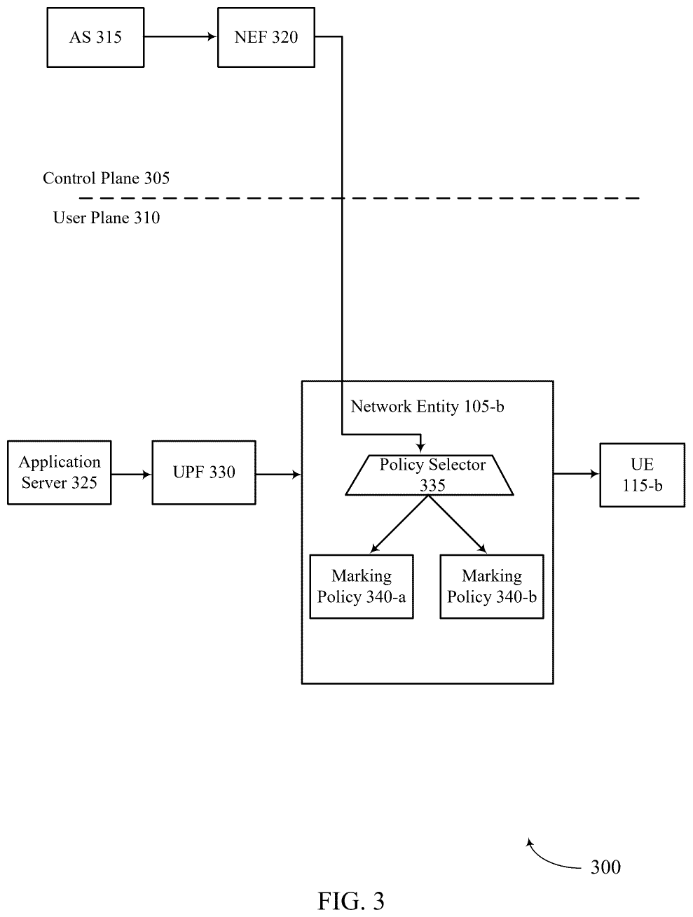

FIG. 3 shows an example of a wireless communications system 300 that supports PDU set-dependent congestion marking in accordance with one or more aspects of the present disclosure. The wireless communications system 300 may implement or may be implemented by aspects of the wireless communications system 100 or the wireless communications system 200. For example, the wireless communications system 300 may be implemented by a UE 115-b, network entity 105-b (e.g., a RAN node), and an application server 325, which may be examples of UEs 115 and network entities 105 as described with reference to FIG. 1.

In some examples, as described with reference to FIG. 2, a network entity 105-b (e.g., a RAN node, a network node) may determine whether to set a value of a congestion decision in a congestion marking field (e.g., an ECN field) to a value that indicates, to a UE 115-b, that the network entity 105-b is experiencing congestion based on one or more PDU set-dependent features. For example, the network entity 105-b may determine whether to indicate, via the ECN field, that congestion is experienced by the network entity 105-b based on a PDU set size, a PSDB, a deadline, and/or a packet index.

Additionally, or alternatively, the network entity 105-b may determine whether to indicate, via the ECN field, that congestion is experienced by the network entity 105-b based on whether pacing is used for the PDU set (e.g., as illustrated with reference to FIG. 2). For example, the network entity 105 may receive an indication from an application function (AF) (e.g., as a PDU set QoS parameter in a QoS profile) that the application (e.g., an application server 325) does or does not perform packet pacing. In some examples (e.g., if one or more application servers are untrusted form operators), the network entity 105-b may receive the pacing information (e.g., that the application does or does not perform packet pacing) from an NEF 320.

For example, the network entity 105-b may receive a pacing indicator (e.g., indicating pacing information, such as whether or not a PDU set will be transmitted by the application server 325 using pacing) from a control plane 305 including an access stratum (AS) 315 and the NEF 320. The network entity 105-b may receive one or more PDUs of the PDU set from one or more devices in a user plane 310 (e.g., the application server 325, a UPF 330). The network entity 105-b may use a policy selector 335 to select a marking policy (e.g., a marking policy 340-a, a marking policy 340-b, one or more additional marking policies) for the one or more PDUs. In some examples, each marking policy may be associated with a different probability that the network entity 105-b may indicate, via the ECN field of the one or more PDUs, that congestion is experienced by the network entity 105-b.

For example, the marking policy 340-a may indicate for the network entity 105-b to refrain from indicating via the ECN field of the one or more PDUs, that congestion is experienced by the network entity 105-b, and the marking policy 340-b may indicate for the network entity 105-b to indicate, via the ECN field of the one or more PDUs, that congestion is experienced by the network entity 105-b. Additionally, or alternatively, the marking policy 340-a may be associated with a first probability function for the network entity 105-b to indicate, via the ECN field of the one or more PDUs, that congestion is experienced (e.g., as a function of queuing delay), and the marking policy 340-b may be associated with a second probability function for the network entity 105-b to indicate, via the ECN field of the one or more PDUs, that congestion is experienced (e.g., as a function of queuing delay).

The network entity 105-b may accordingly adjust a value of the congestion decision (e.g., the ECN field) of the one or more PDUs in accordance with the selected marking policy. The network entity 105-b may output the one or more PDUs to the UE 115-b. As an illustrative example, the network entity 105-a may select a marking policy 340-a with a relatively higher probability for the network entity 105-b to indicate, via the ECN field of the one or more PDUs, that congestion is experienced when the PDU set is transmitted using pacing. The network entity 105-a may select a marking policy 340-b with a relatively lower probability for the network entity 105-b to indicate, via the ECN field of the one or more PDUs, that congestion is experienced when the PDU set is not transmitted using pacing. In some examples, the network entity 105-a may select a marking policy 340 (e.g., or may adjust a marking policy 340) based on one or more additional PDU set-specific features (e.g., a PSDB, a PDU set size, a deadline, and the like), as described with reference to FIG. 2.

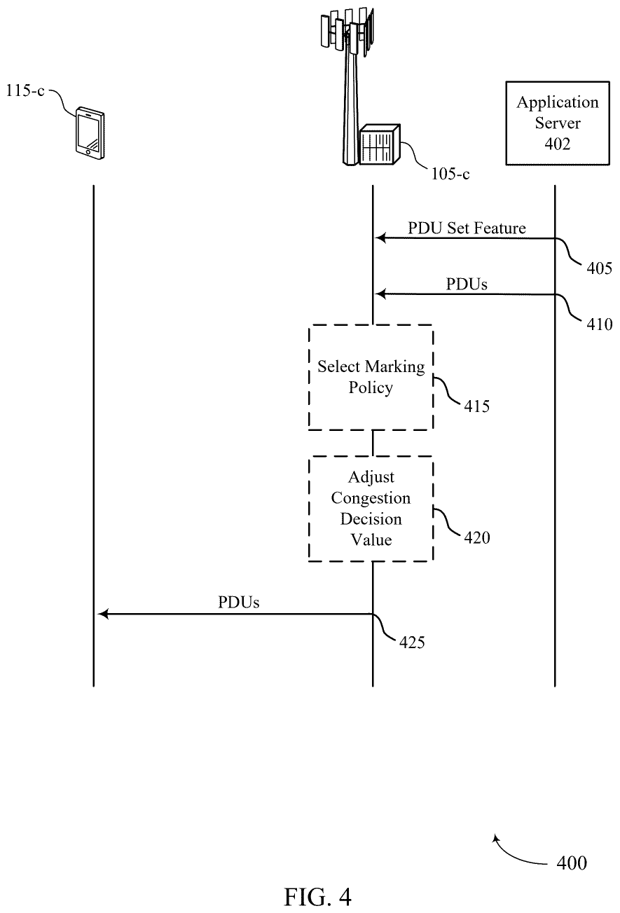

FIG. 4 shows an example of a process flow 400 that supports PDU set-dependent congestion marking in accordance with one or more aspects of the present disclosure. The process flow 400 may implement or may be implemented by aspects of the wireless communications system 100 or the wireless communications system 200. For example, the process flow 400 may be implemented by a UE 115-c, a network entity 105-c (e.g., a RAN node), and an application service 402, which may be examples of UEs 115 and network entities 105 as described with reference to FIG. 1.

In the following description of the process flow 400, the operations between the UE 115-c, a network entity 105-c, and the application server 402 may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

At 405, the network entity 105-c may receive a control message indicating a PDU set-specific feature of a PDU set. The network entity 105-c may receive the control message from a management entity associated with the network entity 105-c, such as an application server 402. For example, the network entity 105-a may receive the indication of the PDU set-specific feature via a QoS profile from the application server 402 or from another device associated with the network entity 105-c (e.g., a UPF, an NEF, an access stratum, and the like). Additionally, or alternatively, the network entity 105-c may receive the indication of the PDU set-specific feature from the UE 115-c. For example, the UE 115-c may indicate a deadline associated with the PDU set to the network entity 105-c. In some examples, the PDU set-specific feature may include a PDU set size, a PSDB, the deadline, one or more QoS parameters, pacing information associated with the PDU set, or any combination thereof.

At 410, the network entity 105-c may receive one or more PDUs of the PDU set. For example, the network entity 105-c may receive the one or more PDUs from the application server 402 or from another device associated with the network entity 105-c (e.g., a UPF, an NEF, an access stratum, and the like).

In some examples, at 415, the network entity 105-c may select a marking policy related to setting a value of a congestion decision indicated by a congestion marking field of the one or more PDUs. For example, the network entity 105-c may select a first marking policy if pacing is used for the PDU set and may select a second marking policy if pacing is not used for the PDU set.

In some examples, at 420, the network entity 105-c may adjust the value of the congestion decision indicated by the congestion marking field based on the PDU set-specific feature (e.g., and/or based on the selected marking policy). For example, the network entity 105-c may adjust the value of the congestion decision based on the PDU set size, the PSDB, the deadline, the one or more QoS parameters, and/or on the pacing information associated with the PDU set. In some examples, the network entity 105-c may indicate, via the congestion marking field, that congestion is experienced or may refrain from indicating, via the congestion marking field, that congestion is experienced. In some examples, the network entity 105-c may determine whether to adjust the value of the congestion decision by adjusting a probability associated with indicating, via the congestion marking field, that congestion is experienced (e.g., based on the PDU set-specific feature).

At 425, the network entity 105-c may output the one or more PDUs of the PDU set to the UE 115-c. In some examples, the network entity 105-c may indicate, to the UE 115-c, whether congestion is experienced by indicating the value of the congestion decision to the UE 115-c via the congestion marking field of the one or more PDUs.

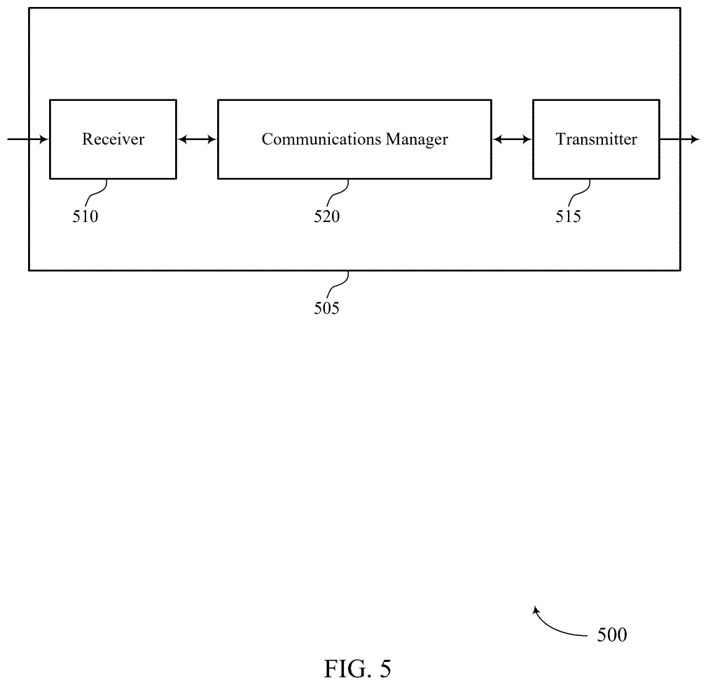

FIG. 5 shows a block diagram 500 of a device 505 that supports PDU set-dependent congestion marking in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of PDU set-dependent congestion marking as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a control message indicating a PDU set-specific feature associated with a PDU set. The communications manager 520 is capable of, configured to, or operable to support a means for receiving one or more PDUs of the PDU set. The communications manager 520 is capable of, configured to, or operable to support a means for outputting the one or more PDUs of the PDU set, where a value of a congestion decision indicated by a congestion marking field of the one or more PDUs output by the first network entity is adjusted based on the PDU set-specific feature associated with the PDU set.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for adjusting congestion marking based on one or more PDU set-specific features, which may result in more efficient utilization of communication resources related to higher bitrates.

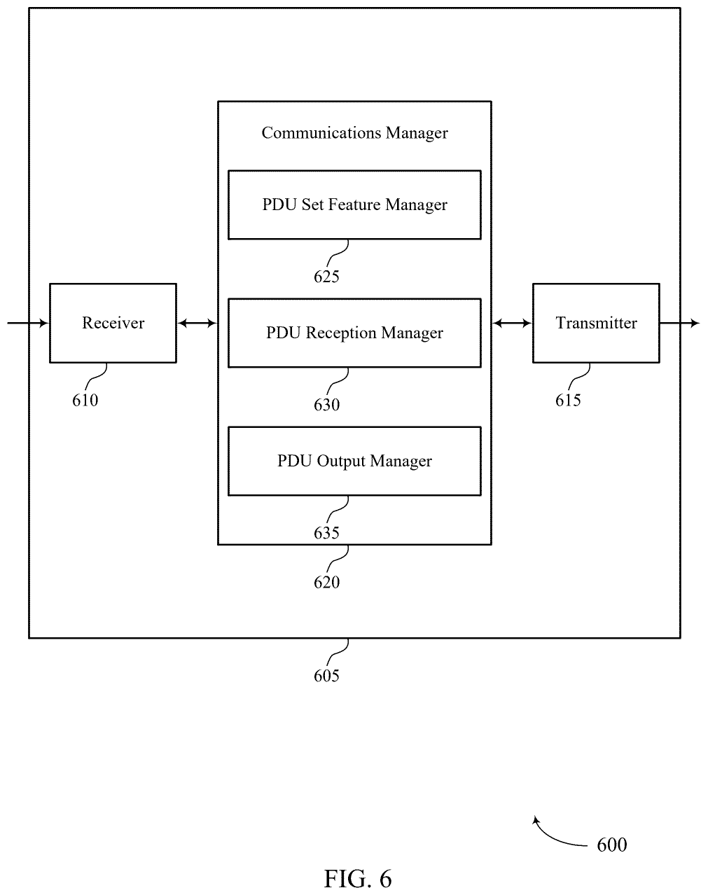

FIG. 6 shows a block diagram 600 of a device 605 that supports PDU set-dependent congestion marking in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of PDU set-dependent congestion marking as described herein. For example, the communications manager 620 may include a PDU set feature manager 625, a PDU reception manager 630, a PDU output manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The PDU set feature manager 625 is capable of, configured to, or operable to support a means for receiving a control message indicating a PDU set-specific feature associated with a PDU set. The PDU reception manager 630 is capable of, configured to, or operable to support a means for receiving one or more PDUs of the PDU set. The PDU output manager 635 is capable of, configured to, or operable to support a means for outputting the one or more PDUs of the PDU set, where a value of a congestion decision indicated by a congestion marking field of the one or more PDUs output by the first network entity is adjusted based on the PDU set-specific feature associated with the PDU set.

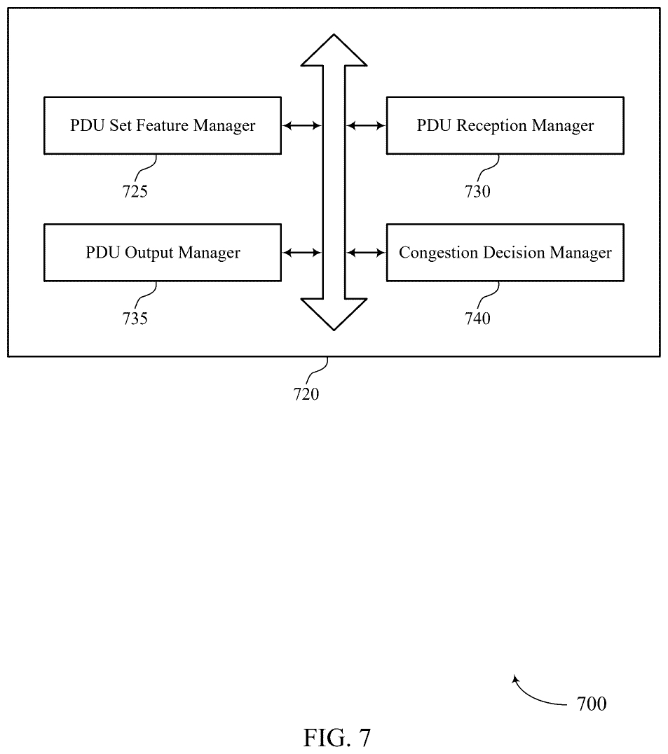

FIG. 7 shows a block diagram 700 of a communications manager 720 that supports PDU set-dependent congestion marking in accordance with one or more aspects of the present disclosure. The communications manager 720 may be an example of aspects of a communications manager 520, a communications manager 620, or both, as described herein. The communications manager 720, or various components thereof, may be an example of means for performing various aspects of PDU set-dependent congestion marking as described herein. For example, the communications manager 720 may include a PDU set feature manager 725, a PDU reception manager 730, a PDU output manager 735, a congestion decision manager 740, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The PDU set feature manager 725 is capable of, configured to, or operable to support a means for receiving a control message indicating a PDU set-specific feature associated with a PDU set. The PDU reception manager 730 is capable of, configured to, or operable to support a means for receiving one or more PDUs of the PDU set. The PDU output manager 735 is capable of, configured to, or operable to support a means for outputting the one or more PDUs of the PDU set, where a value of a congestion decision indicated by a congestion marking field of the one or more PDUs output by the first network entity is adjusted based on the PDU set-specific feature associated with the PDU set.

In some examples, to support receiving the control message indicating the PDU set-specific feature, the PDU set feature manager 725 is capable of, configured to, or operable to support a means for receiving an indication of a PSDB associated with the PDU set, where the value of the congestion decision indicated by the congestion marking field is adjusted based on a function of the PSDB for the one or more PDUs output by the first network entity.

In some examples, to support receiving the control message indicating the PDU set-specific feature, the PDU set feature manager 725 is capable of, configured to, or operable to support a means for receiving an indication of a PDU set size associated with the PDU set, where the value of the congestion decision indicated by the congestion marking field is adjusted based on a packet index for the one or more PDUs output by the first network entity.

In some examples, to support receiving the control message indicating the PDU set-specific feature, the PDU set feature manager 725 is capable of, configured to, or operable to support a means for receiving an indication of a deadline associated with the PDU set, where the value of the congestion decision indicated by the congestion marking field is adjusted based on an amount of remaining time before the deadline for the one or more PDUs output by the first network entity.

In some examples, to support receiving the control message indicating the PDU set-specific feature, the PDU set feature manager 725 is capable of, configured to, or operable to support a means for receiving an indication of one or more QoS parameters associated with the PDU set, where the value of the congestion decision indicated by the congestion marking field is adjusted based on the one or more QoS parameters.

In some examples, to support receiving the control message indicating the PDU set-specific feature, the PDU set feature manager 725 is capable of, configured to, or operable to support a means for receiving an indication of pacing information associated with the PDU set, where the value of the congestion decision indicated by the congestion marking field is adjusted based on the pacing information.

In some examples, the congestion decision manager 740 is capable of, configured to, or operable to support a means for adjusting the value of the congestion decision indicated by the congestion marking field based on the PDU set-specific feature.

In some examples, to support adjusting the value of the congestion decision, the congestion decision manager 740 is capable of, configured to, or operable to support a means for adjusting a probability associated with indicating, via the congestion marking field, that congestion is experienced based on the PDU set-specific feature.

In some examples, to support adjusting the value of the congestion decision, the congestion decision manager 740 is capable of, configured to, or operable to support a means for indicating, via the congestion marking field, that congestion is experienced based on the PDU set-specific feature.

In some examples, to support adjusting the value of the congestion decision, the congestion decision manager 740 is capable of, configured to, or operable to support a means for refraining from indicating, via the congestion marking field, that congestion is experienced based on the PDU set-specific feature.

In some examples, to support receiving the control message indicating the PDU set-specific feature, the PDU set feature manager 725 is capable of, configured to, or operable to support a means for receiving a QoS profile including an indication of the PDU set-specific feature.

In some examples, the congestion decision manager 740 is capable of, configured to, or operable to support a means for selecting a marking policy associated with adjusting the value of the congestion decision indicated by the congestion marking field of the one or more PDUs based on the PDU set-specific feature.

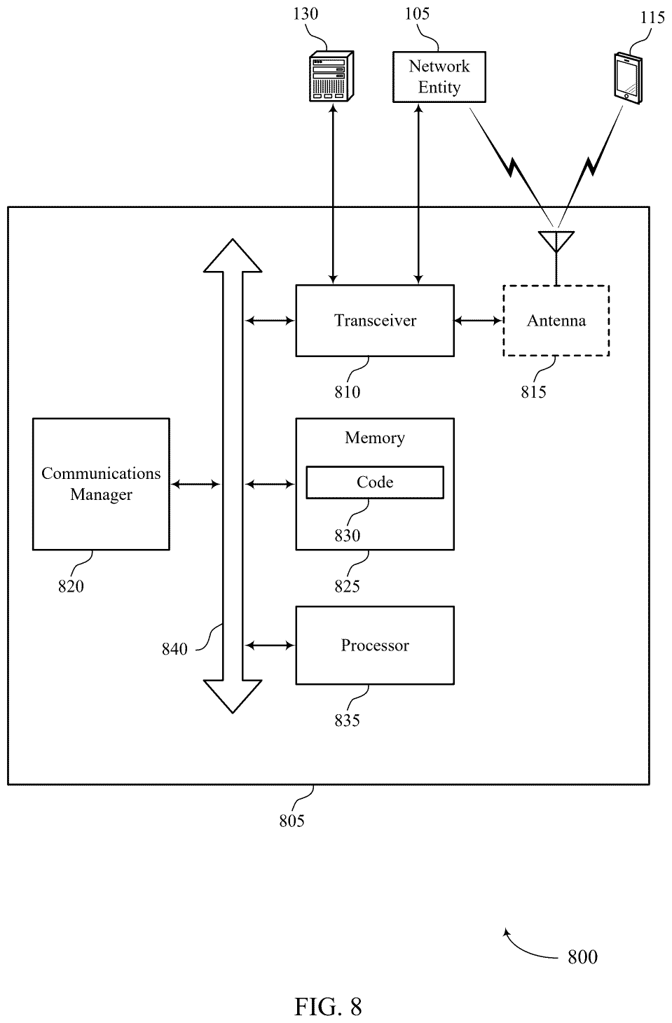

FIG. 8 shows a diagram of a system 800 including a device 805 that supports PDU set-dependent congestion marking in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting PDU set-dependent congestion marking). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for receiving a control message indicating a PDU set-specific feature associated with a PDU set. The communications manager 820 is capable of, configured to, or operable to support a means for receiving one or more PDUs of the PDU set. The communications manager 820 is capable of, configured to, or operable to support a means for outputting the one or more PDUs of the PDU set, where a value of a congestion decision indicated by a congestion marking field of the one or more PDUs output by the first network entity is adjusted based on the PDU set-specific feature associated with the PDU set.

By including or configuring the communications manager 820 in accordance with examples as described herein, the device 805 may support techniques for adjusting congestion marking based on one or more PDU set-specific features, which may result in reduced latency, improved user experience, and more efficient utilization of communication resources related to higher bitrates.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of PDU set-dependent congestion marking as described herein, or the at least one processor 835 and the at least one memory 825 may be otherwise configured to, individually or collectively, perform or support such operations.

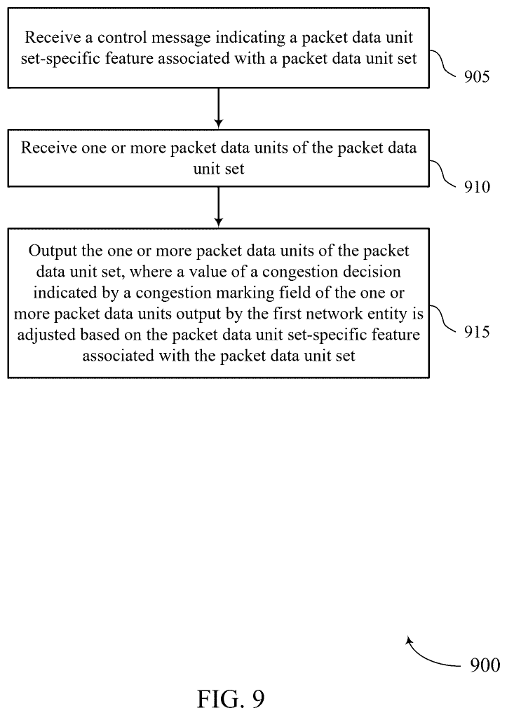

FIG. 9 shows a flowchart illustrating a method 900 that supports PDU set-dependent congestion marking in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include receiving a control message indicating a PDU set-specific feature associated with a PDU set. The operations of 905 may be performed in accordance with examples as disclosed herein. In some examples, aspects of the operations of 905 may be performed by a PDU set feature manager 725 as described with reference to FIG. 7.

At 910, the method may include receiving one or more PDUs of the PDU set. The operations of 910 may be performed in accordance with examples as disclosed herein. In some examples, aspects of the operations of 910 may be performed by a PDU reception manager 730 as described with reference to FIG. 7.

At 915, the method may include outputting the one or more PDUs of the PDU set, where a value of a congestion decision indicated by a congestion marking field of the one or more PDUs output by the first network entity is adjusted based on the PDU set-specific feature associated with the PDU set. The operations of 915 may be performed in accordance with examples as disclosed herein. In some examples, aspects of the operations of 915 may be performed by a PDU output manager 735 as described with reference to FIG. 7.

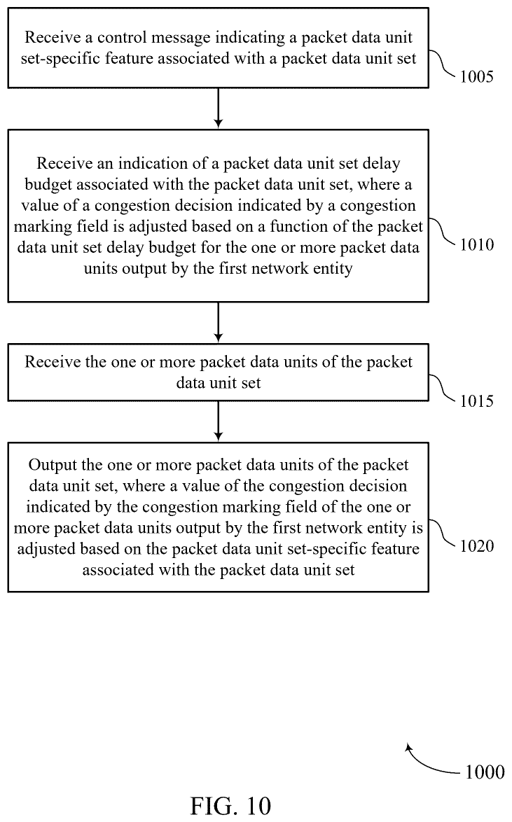

FIG. 10 shows a flowchart illustrating a method 1000 that supports PDU set-dependent congestion marking in accordance with one or more aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include receiving a control message indicating a PDU set-specific feature associated with a PDU set. The operations of 1005 may be performed in accordance with examples as disclosed herein. In some examples, aspects of the operations of 1005 may be performed by a PDU set feature manager 725 as described with reference to FIG. 7.

At 1010, the method may include receiving an indication of a PSDB associated with the PDU set, where a value of a congestion decision indicated by a congestion marking field is adjusted based on a function of the PSDB for one or more PDUs output by the first network entity. The operations of 1010 may be performed in accordance with examples as disclosed herein. In some examples, aspects of the operations of 1010 may be performed by a PDU set feature manager 725 as described with reference to FIG. 7.

At 1015, the method may include receiving the one or more PDUs of the PDU set. The operations of 1015 may be performed in accordance with examples as disclosed herein. In some examples, aspects of the operations of 1015 may be performed by a PDU reception manager 730 as described with reference to FIG. 7.

At 1020, the method may include outputting the one or more PDUs of the PDU set, where the value of the congestion decision indicated by the congestion marking field of the one or more PDUs output by the first network entity is adjusted based on the PDU set-specific feature associated with the PDU set. The operations of 1020 may be performed in accordance with examples as disclosed herein. In some examples, aspects of the operations of 1020 may be performed by a PDU output manager 735 as described with reference to FIG. 7.

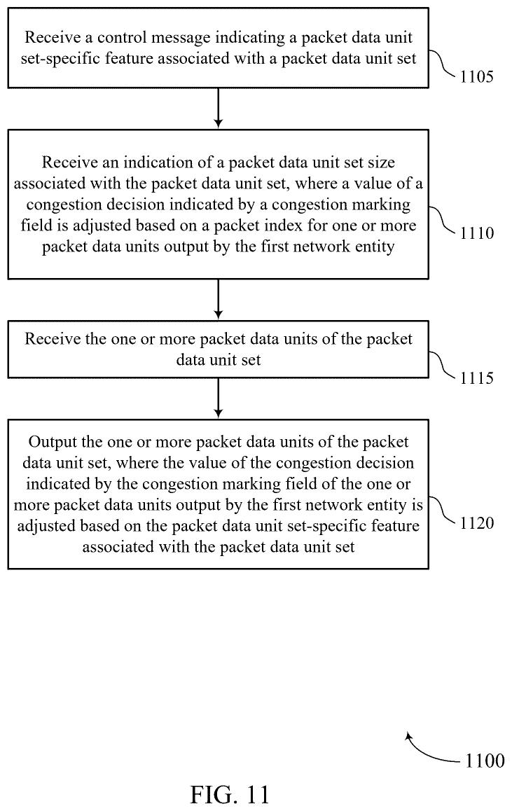

FIG. 11 shows a flowchart illustrating a method 1100 that supports PDU set-dependent congestion marking in accordance with one or more aspects of the present disclosure. The operations of the method 1100 may be implemented by a network entity or its components as described herein. For example, the operations of the method 1100 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1105, the method may include receiving a control message indicating a PDU set-specific feature associated with a PDU set. The operations of 1105 may be performed in accordance with examples as disclosed herein. In some examples, aspects of the operations of 1105 may be performed by a PDU set feature manager 725 as described with reference to FIG. 7.

At 1110, the method may include receiving an indication of a PDU set size associated with the PDU set, where a value of a congestion decision indicated by a congestion marking field is adjusted based on a packet index for one or more PDUs output by the first network entity. The operations of 1110 may be performed in accordance with examples as disclosed herein. In some examples, aspects of the operations of 1110 may be performed by a PDU set feature manager 725 as described with reference to FIG. 7.

At 1115, the method may include receiving the one or more PDUs of the PDU set. The operations of 1115 may be performed in accordance with examples as disclosed herein. In some examples, aspects of the operations of 1115 may be performed by a PDU reception manager 730 as described with reference to FIG. 7.

At 1120, the method may include outputting the one or more PDUs of the PDU set, where the value of the congestion decision indicated by the congestion marking field of the one or more PDUs output by the first network entity is adjusted based on the PDU set-specific feature associated with the PDU set. The operations of 1120 may be performed in accordance with examples as disclosed herein. In some examples, aspects of the operations of 1120 may be performed by a PDU output manager 735 as described with reference to FIG. 7.

The following provides an overview of aspects of the present disclosure:

Aspect 1: A method for wireless communications by a first network entity, comprising: receiving a control message indicating a PDU set-specific feature associated with a PDU set; receiving one or more PDUs of the PDU set; and outputting the one or more PDUs of the PDU set, wherein a value of a congestion decision indicated by a congestion marking field of the one or more PDUs output by the first network entity is adjusted based at least in part on the PDU set-specific feature associated with the PDU set.

Aspect 2: The method of aspect 1, wherein receiving the control message indicating the PDU set-specific feature comprises: receiving an indication of a PSDB associated with the PDU set, wherein the value of the congestion decision indicated by the congestion marking field is adjusted based at least in part on a function of the PSDB for the one or more PDUs output by the first network entity.

Aspect 3: The method of any of aspects 1 through 2, wherein receiving the control message indicating the PDU set-specific feature comprises: receiving an indication of a PDU set size associated with the PDU set, wherein the value of the congestion decision indicated by the congestion marking field is adjusted based at least in part on a packet index for the one or more PDUs output by the first network entity.

Aspect 4: The method of any of aspects 1 through 3, wherein receiving the control message indicating the PDU set-specific feature comprises: receiving an indication of a deadline associated with the PDU set, wherein the value of the congestion decision indicated by the congestion marking field is adjusted based at least in part on an amount of remaining time before the deadline for the one or more PDUs output by the first network entity.

Aspect 5: The method of any of aspects 1 through 4, wherein receiving the control message indicating the PDU set-specific feature comprises: receiving an indication of one or more QoS parameters associated with the PDU set, wherein the value of the congestion decision indicated by the congestion marking field is adjusted based at least in part on the one or more QoS parameters.

Aspect 6: The method of any of aspects 1 through 5, wherein receiving the control message indicating the PDU set-specific feature comprises: receiving an indication of pacing information associated with the PDU set, wherein the value of the congestion decision indicated by the congestion marking field is adjusted based at least in part on the pacing information.

Aspect 7: The method of any of aspects 1 through 6, further comprising: adjusting the value of the congestion decision indicated by the congestion marking field based at least in part on the PDU set-specific feature.

Aspect 8: The method of aspect 7, wherein adjusting the value of the congestion decision comprises: adjusting a probability associated with indicating, via the congestion marking field, that congestion is experienced based at least in part on the PDU set-specific feature.

Aspect 9: The method of any of aspects 7 through 8, wherein adjusting the value of the congestion decision comprises: indicating, via the congestion marking field, that congestion is experienced based at least in part on the PDU set-specific feature.

Aspect 10: The method of any of aspects 7 through 8, wherein adjusting the value of the congestion decision comprises: refraining from indicating, via the congestion marking field, that congestion is experienced based at least in part on the PDU set-specific feature.

Aspect 11: The method of any of aspects 1 through 10, wherein receiving the control message indicating the PDU set-specific feature comprises: receiving a QoS profile comprising an indication of the PDU set-specific feature.

Aspect 12: The method of any of aspects 1 through 11, further comprising: selecting a marking policy associated with adjusting the value of the congestion decision indicated by the congestion marking field of the one or more PDUs based at least in part on the PDU set-specific feature.

Aspect 13: A first network entity for wireless communications, comprising one or more memories storing processor-executable code, and one or more processors coupled with the one or more memories and individually or collectively operable to execute the code to cause the first network entity to perform a method of any of aspects 1 through 12.

Aspect 14: A first network entity for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
one or more memories storing processor-executable code; and
one or more processors coupled with the one or more memories and individually or collectively operable to execute the code to cause the first network entity to:
receive a control message indicating a packet data unit set-specific feature associated with a packet data unit set;
receive one or more packet data units of the packet data unit set; and
output the one or more packet data units of the packet data unit set, wherein a value of a congestion decision indicated by a congestion marking field of the one or more packet data units output by the first network entity is adjusted based at least in part on the packet data unit set-specific feature associated with the packet data unit set.

2. The first network entity of claim 1, wherein, to receive the control message indicating the packet data unit set-specific feature, the one or more processors are individually or collectively operable to execute the code to cause the first network entity to:
receive an indication of a packet data unit set delay budget associated with the packet data unit set, wherein the value of the congestion decision indicated by the congestion marking field is adjusted based at least in part on a function of the packet data unit set delay budget for the one or more packet data units output by the first network entity.

3. The first network entity of claim 1, wherein, to receive the control message indicating the packet data unit set-specific feature, the one or more processors are individually or collectively operable to execute the code to cause the first network entity to:
receive an indication of a packet data unit set size associated with the packet data unit set, wherein the value of the congestion decision indicated by the congestion marking field is adjusted based at least in part on a packet index for the one or more packet data units output by the first network entity.

4. The first network entity of claim 1, wherein, to receive the control message indicating the packet data unit set-specific feature, the one or more processors are individually or collectively operable to execute the code to cause the first network entity to:
receive an indication of a deadline associated with the packet data unit set, wherein the value of the congestion decision indicated by the congestion marking field is adjusted based at least in part on an amount of remaining time before the deadline for the one or more packet data units output by the first network entity.

5. The first network entity of claim 1, wherein, to receive the control message indicating the packet data unit set-specific feature, the one or more processors are individually or collectively operable to execute the code to cause the first network entity to:
receive an indication of one or more quality of service parameters associated with the packet data unit set, wherein the value of the congestion decision indicated by the congestion marking field is adjusted based at least in part on the one or more quality of service parameters.

6. The first network entity of claim 1, wherein, to receive the control message indicating the packet data unit set-specific feature, the one or more processors are individually or collectively operable to execute the code to cause the first network entity to:
receive an indication of pacing information associated with the packet data unit set, wherein the value of the congestion decision indicated by the congestion marking field is adjusted based at least in part on the pacing information.

7. The first network entity of claim 1, wherein the one or more processors are individually or collectively further operable to execute the code to cause the first network entity to:
adjust the value of the congestion decision indicated by the congestion marking field based at least in part on the packet data unit set-specific feature.

8. The first network entity of claim 7, wherein, to adjust the value of the congestion decision, the one or more processors are individually or collectively operable to execute the code to cause the first network entity to:
adjust a probability associated with indicating, via the congestion marking field, that congestion is experienced based at least in part on the packet data unit set-specific feature.

9. The first network entity of claim 7, wherein, to adjust the value of the congestion decision, the one or more processors are individually or collectively operable to execute the code to cause the first network entity to:
indicate, via the congestion marking field, that congestion is experienced based at least in part on the packet data unit set-specific feature.

10. The first network entity of claim 7, wherein, to adjust the value of the congestion decision, the one or more processors are individually or collectively operable to execute the code to cause the first network entity to:
refrain from indicating, via the congestion marking field, that congestion is experienced based at least in part on the packet data unit set-specific feature.

11. The first network entity of claim 1, wherein, to receive the control message indicating the packet data unit set-specific feature, the one or more processors are individually or collectively operable to execute the code to cause the first network entity to:
receive a quality of service profile comprising an indication of the packet data unit set-specific feature.

12. The first network entity of claim 1, wherein the one or more processors are individually or collectively further operable to execute the code to cause the first network entity to:
select a marking policy associated with adjusting the value of the congestion decision indicated by the congestion marking field of the one or more packet data units based at least in part on the packet data unit set-specific feature.

13. A method for wireless communications by a first network entity, comprising:
receiving a control message indicating a packet data unit set-specific feature associated with a packet data unit set;
receiving one or more packet data units of the packet data unit set; and
outputting the one or more packet data units of the packet data unit set, wherein a value of a congestion decision indicated by a congestion marking field of the one or more packet data units output by the first network entity is adjusted based at least in part on the packet data unit set-specific feature associated with the packet data unit set.

14. The method of claim 13, wherein receiving the control message indicating the packet data unit set-specific feature comprises:
receiving an indication of a packet data unit set delay budget associated with the packet data unit set, wherein the value of the congestion decision indicated by the congestion marking field is adjusted based at least in part on a function of the packet data unit set delay budget for the one or more packet data units output by the first network entity.

15. The method of claim 13, wherein receiving the control message indicating the packet data unit set-specific feature comprises:
receiving an indication of a packet data unit set size associated with the packet data unit set, wherein the value of the congestion decision indicated by the congestion marking field is adjusted based at least in part on a packet index for the one or more packet data units output by the first network entity.

16. The method of claim 13, wherein receiving the control message indicating the packet data unit set-specific feature comprises:
receiving an indication of a deadline associated with the packet data unit set, wherein the value of the congestion decision indicated by the congestion marking field is adjusted based at least in part on an amount of remaining time before the deadline for the one or more packet data units output by the first network entity.

17. The method of claim 13, wherein receiving the control message indicating the packet data unit set-specific feature comprises:
receiving an indication of one or more quality of service parameters associated with the packet data unit set, wherein the value of the congestion decision indicated by the congestion marking field is adjusted based at least in part on the one or more quality of service parameters.

18. The method of claim 13, wherein receiving the control message indicating the packet data unit set-specific feature comprises:
receiving an indication of pacing information associated with the packet data unit set, wherein the value of the congestion decision indicated by the congestion marking field is adjusted based at least in part on the pacing information.

19. The method of claim 13, further comprising:
adjusting the value of the congestion decision indicated by the congestion marking field based at least in part on the packet data unit set-specific feature.

20. A non-transitory computer-readable medium storing code for wireless communications, the code comprising instructions executable by one or more processors to:
receive, at a first network entity, a control message indicating a packet data unit set-specific feature associated with a packet data unit set;
receive one or more packet data units of the packet data unit set; and
output the one or more packet data units of the packet data unit set, wherein a value of a congestion decision indicated by a congestion marking field of the one or more packet data units output by the first network entity is adjusted based at least in part on the packet data unit set-specific feature associated with the packet data unit set.
